(19) United States
(12) Patent Application Publication
(10) Pub. No.: US 2002/0126490 A1
(43) Pub. Date: Sep. 12, 2002

(54) Collapsible lampshade structure

(76) Inventor: Hsih Bin Chou, Huntington Beach, CA (US)

Correspondence Address: CHARLES C.H. WU, ESQ., CHARLES C.H. WU & ASSOCIATES, APC, 7700 IRVINE CENTER DRIVE, SUITE 710, IRVINE, CA, 92618-3043, US

(21) Appl. No.: 09/803,555

(22) Filed: Mar. 12, 2001

(51) Int. Cl. F21V 11/00; F21V 1/06

(52) U.S. Cl. 362/352; 362/351

(57) ABSTRACT

The invention is a collapsible lampshade comprising: a rigid upper structure, said rigid upper structure forming a plurality of upper notches, a rigid lower structure, said rigid lower structure forming a plurality of lower notches, a flexible fabric joining said rigid upper structure with said rigid lower structure, supporting rods having a first end and a second end, said first end capable of inserting into said plurality of upper notches, said second end capable of inserting into said plurality of lower notches, whereby a user assembles said collapsible lampshade.

### BACKGROUND OF THE INVENTION

Traditional lampshades are constructed from a rigid frame surrounded in fabric. The standard lamp shade is made from an upper ring and a lower ring connected by rigid fabric or by flexible fabric held with supporting rods. The supporting rods usually accept a compression force. The flexible fabric usually accepts a tensile force. The construction of a lampshade having supporting rods requires the rods to be connected to the fabric. The fabric is sometimes sewn around the rod. Because the structure comprising the fabric, surrounding rods and frame are constructed as a unit, the lampshade requires substantial volume. The lampshade is also usually packaged in a transparent plastic bag, further adding volume.

One method of transporting lampshades requires stacking the lampshades. Unfortunately stacking is not possible when shipping individual lampshades. Lampshades stacked in bulk cannot be packaged with their respective lamps.

### SUMMARY OF INVENTION

The invention is a lampshade that collapses to conserve storage space. An upper structure such as a ring having fabric, ring, rod holders, sockets, or hinges, and a lower structure connected by fabric, ring, rod holders, sockets, or hinges, are held apart by disconnectable rods. When the rods are disassembled, the lampshade can collapse to become flat.

### BRIEF DESCRIPTION OF THE DRAWINGS

FIG. 1 is a diagram of the lampshade showing the basic elements

FIG. 2 is a close up drawing of a notch

FIG. 3 is a close up drawing of a swivel brace

FIG. 4 is a cut away drawing showing the inside surface of a lampshade.

### DESCRIPTION OF THE PREFERRED EMBODIMENT

### Field of the Invention

The present invention relates to a collapsible lampshade for conserving storage and shipping volume.

### Detailed Description

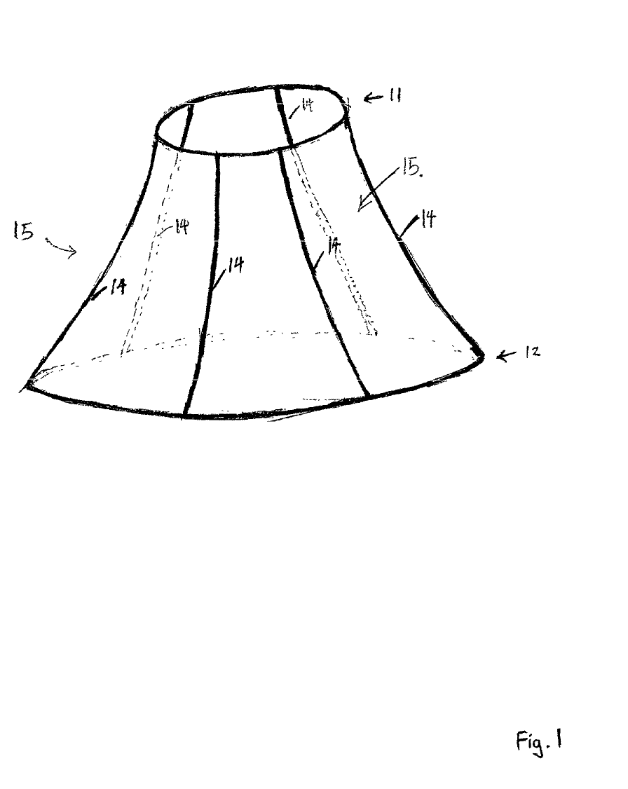

A collapsible lampshade can conserve shipping volume. The preferred embodiment FIG. 1 is comprised of an upper rigid structure 11 connected to a lower rigid structure 12 by fabric 15 and supported by a plurality of rod members 14. When a lampshade is cylindrical in shape, the upper rigid structure 11 and lower rigid structure 12 are flat metal rings attached to the fabric 15 by wrapping the fabric circumferentially about the rigid rings 11, 12. The fabric can be sewn or glued around the ring allowing retention of the fabric in a direction perpendicular to the surface of the ring.

Sometimes, a lampshade is constructed with a rigid fabric connecting the upper and lower rings. In this case, rods would not be necessary. The preferred embodiment encompasses the situation where the lampshade is constructed with a flexible and soft fabric connecting the upper and lower rings. The fabric can be made of plastic, paper, or any thin material.

With a sheet of soft cloth joining two rings, the lampshade lacks rigidity. While some lampshades hang loosely from the lower ring, it is sometimes preferred to create a rigid structure. Supporting rod members inserted between the upper rigid structure 11 and lower rigid structure 12 provides rigidity to the shade. The rods act as ribs accepting a compressive force against the tensile force of the lamp fabric. Sometimes the tensile force can flexibly bend the rods to allow various artistic designs.

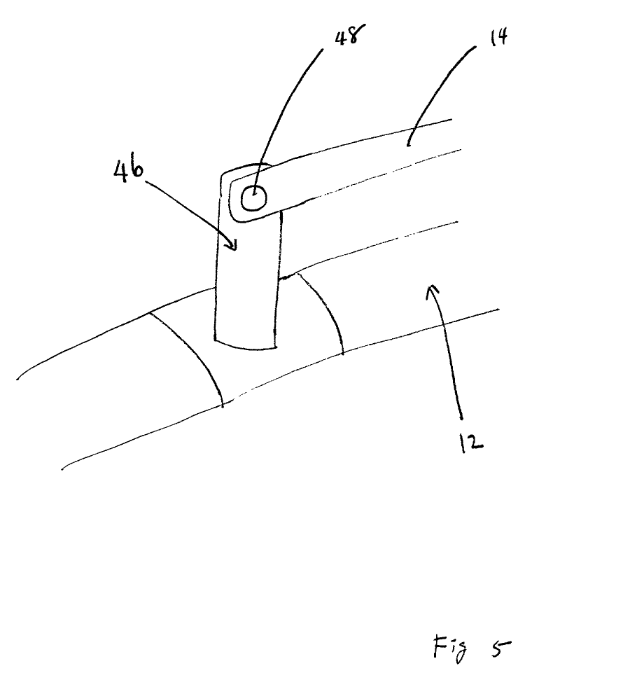

More design possibilities can be created when the fabric 15 of the lampshade can be attached to the rods 14. Many lampshade structures can be further improved by attaching the fabric 15 to the supporting rods 14. The preferred means to attach the fabric 15 to supporting rods 14 is by retaining the fabric in a guiding sleeve FIG. 4, 44. FIG. 4 shows a lampshade cutaway drawing of the rods 14 through the sleeves 44. When assembling the lampshade structure, the user first inserts a supporting rod through the guiding sleeve 44. The sleeve 44 is attached to the lampshade fabric 15.

Other means of attaching a rod to a lampshade fabric include glue, Staples, ultrasonic welding and the like. A lampshade fabric can also be perforated with a plurality of holes linearly aligned to the path of a supporting rod. The rod can then be inserted and threaded through the holes thereby retaining the lampshade fabric. Small rings sewn into the lampshade fabric can also replace the guiding sleeve.

The rods and sleeves or other attachment means can be mounted on the inside surface of the lampshade or on the outside. If the rods are mounted on the outside, the rods and the sleeves are visible in ordinary use. Because such a design is non-standard in the industry for aesthetic purposes, applicant suggests that the best mode is the traditional method of mounting the sleeves and rods on the inside surface of the fabric of the lampshade.

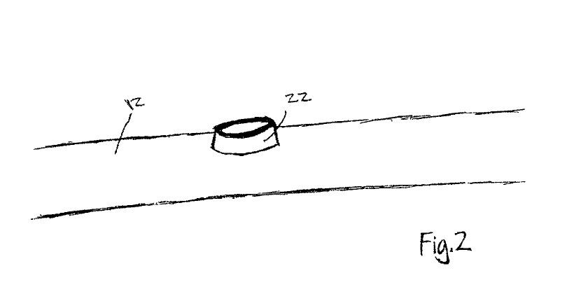

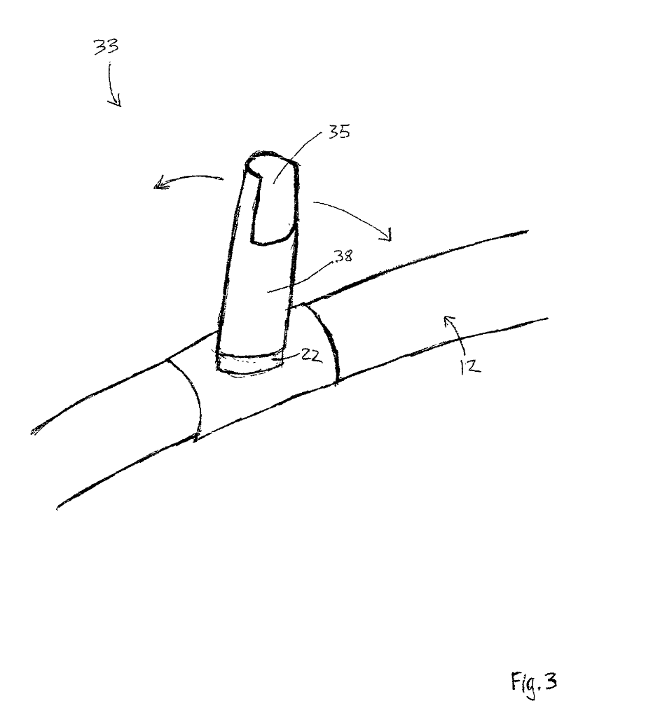

The rods are traditionally welded such that they are permanently connected to the upper ring and the lower ring. In a collapsible lampshade, the rods are held in FIG. 2 sockets 22 also called notches 22. The compressive force sometimes sufficient to bend the rods FIG. 1, 14 also maintains them in the sockets. The sockets 22 are usually rigidly connected to the upper ring 11 and the lower ring 12.

The supporting member rods are preferably rods 14 that can also be flat pieces of rigid plastic, or bamboo. Because they need not be welded, they can be made of various materials that are perhaps better suited than metal for the construction of a lampshade.

Assembly of the lampshade begins by opening the lampshade and separating the upper and lower rigid structures. Unfurling the fabric reveals sleeves that can receive rods. A user inserts the rods into the sleeves 44. The upper and lower rigid structures have notches FIG. 2, 22 shaped to receive the ends of a rod. The first end of a supporting rod member fits into the upper rigid structure 11 and the second end of the supporting rod is designed to fit into a corresponding notch in the lower rigid structure 12. The notches 22 are preferably equal distantly spaced such that they are located at the same places where the rods would otherwise be permanently connected.

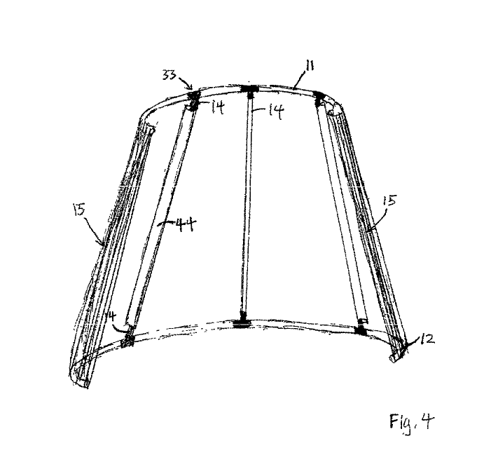

The tension in the fabric 15 can sometimes make it difficult to insert a rod into a notch 22. A swivel guiding brace FIG. 3, 33 can make it easier for a user to insert the rod into a notch 22 and make it easier for a user to manually assemble the lampshade structure. A swivel guiding brace 33 is a short tube capable of receiving the end of a rod and attached to a rigid structure 11, 12. When a circular rigid structure 11, 12 should be made of a thick wire having a circular cross section, the structure defines a ring. A swivel guiding brace 33 in this case swivels to define a circular path and plane perpendicular to the wire. A swivel brace has an upper portion 35 and a lower portion 38. The lower portion 38 is a tube capable of receiving a rod. The upper portion 35 is a half tube that is cut longitudinally and has a semicircular cross section. The upper portion 35 with semicircular cross section can receive the rod laterally where the rod enters the upper portion of the brace from the side of the brace. To operate a lower swivel brace 33, a user first inserts a first end of a supporting rod into a notch 22 in the upper structure. The user aligns the second end of the rod with the upper portion of the lower swivel brace. The user then rotates the swivel brace 33 towards the second end of the rod, which acts as a lever to guide the second end of the rod into the lower portion of the swivel brace 38 and into the notch 22.

Another method of holding the supporting rods 14 is using hinges FIG. 5, 46. The supporting rods 14 are attached to the upper 11 or the lower 12 structure through the hinges 46 by having hinge pins 48 connecting the supporting rods 14 to either or both of the upper 11 or the lower structures 12.

What is claimed is:

1. a collapsible lampshade comprising:
a. a rigid upper structure, said rigid upper structure forming a plurality of upper notches;
b. a rigid lower structure, said rigid lower structure forming a plurality of lower notches;
c. a flexible fabric joining said rigid upper structure with said rigid lower structure; and
d. supporting rods having a first end and a second end, said first end capable of inserting into said plurality of upper notches, said second end capable of inserting into said plurality of lower notches, whereby a user assembles said collapsible lampshade.

2. The collapsible lampshade of claim 1, further comprising: sleeves attached along their length to said flexible fabric and aligned with the path of supporting rods, said supporting rods inserted through the sleeves during assembly, whereby sleeves connect said supporting rods to said fabric allowing artistic shaping of the collapsible lampshade.

3. A collapsible lampshade of claim 2, wherein said sleeves are either sewn or stitched to the inside surface of the fabric.

4. The collapsible lampshade of claim 1, further comprising: holes formed in the flexible fabric and aligned with the path of supporting rods, said supporting rods threaded through the holes during assembly, whereby holes allow said supporting rods to connect with said fabric allowing artistic shaping of the collapsible lampshade.

5. The collapsible lampshade of claim 1, further comprising: loops attached to said flexible fabric and aligned with the path of supporting rods, said supporting rods inserted through the loops during assembly, whereby loops connect said supporting rods to said fabric allowing artistic shaping of the collapsible lampshade.

6. The collapsible lampshade of claim 5, wherein said loops are made of a flexible fabric.

7. The collapsible lampshade of claim 6, wherein said loops are circular metal rings.

8. The collapsible lampshade of claim 1, wherein said lampshade is formed having a relatively cylindrical design, said a rigid upper structure formed as a circular ring, said lower structure formed as a circular ring.

9. The collapsible lampshade of claim 1, further comprising a plurality of swivel braces attached with a pin joint to allow motion only in a plane perpendicular to a wire forming a rigid structure, said swivel braces attached at various locations where notches are formed, said swivel braces having:
a. an upper portion of a semicircular cross section, capable of laterally receiving an end of a supporting rod;
b. a lower portion formed as a hollow tube shaped to receive an end of a supporting rod, and positioned to guide an end of a supporting rod into a notch;
wherein, said swivel brace upper portion guides said end of a supporting rod into said lower portion when a user aligns said end of a supporting rod with said upper portion of a semicircular cross section and rotates said swivel brace to force said end of a supporting rod into said swivel brace lower portion.

10. The collapsible lampshade of claim 9, wherein said swivel brace lower portion is integrally formed with said plurality of lower notches.

11. The collapsible lampshade of claim 9, wherein said supporting rods are permanently connected to all lower swivel braces.

12. The collapsible lampshade of claim 11, wherein said supporting rods are permanently connected to all upper swivel braces.

13. The collapsible lampshade of claim 11, further comprising a plurality of hinges attached at various locations where notches are formed, said hinges having lower portions are attached to the upper structure, said hinges further having a hole and a pin for attaching to the support rod.

14. The collapsible lampshade of claim 13, wherein said hinges lower portions are integrally formed with said plurality of lower notches.

15. The collapsible lampshade of claim 13, wherein said supporting rods are permanently connected to all lower hinges.

16. The collapsible lampshade of claim 13, wherein said supporting rods are permanently connected to all upper hinges.
